(19) United States
(12) Patent Application Publication
(10) Pub. No.: US 2010/0255795 A1
(43) Pub. Date: Oct. 7, 2010

(54) Cellular Phone Enabled Medical Imaging System

(75) Inventors: Boris Rubinsky, El Cerrito, CA (US); Antoni Ivorra, Berkeley, CA (US); Yair Granot, Modi'in (IL)

Correspondence Address: UC Berkeley - OTL;Bozicevic, Field & Francis LLP, 1900 University Avenue, Suite 200, East Palo Alto, CA, 94303, US

(73) Assignees: The Regents of the University of California, Oakland, CA (US); Yissum Research Development Company of the Hebrew Univesity of Jersusalem, Givat Ram, Jerusalem (IL)

(21) Appl. No.: 12/664,866

(22) PCT Filed: Jun. 17, 2008
(86) PCT No.: PCT/US08/07605

§ 371 Date: May 21, 2010

Related U.S. Application Data
(60) Provisional application No. 60/936,063, filed on Jun. 18, 2007.

(51) Int. Cl. H04W 4/00

(52) U.S. Cl. 455/90.1

(57) ABSTRACT

An imaging system, having: an imaging data acquisition device; a remote image reconstruction and data processing facility; and a handheld cell phone type-device, wherein the cell phone type-device wirelessly transmits raw data from the imaging data acquisition device to the remote image reconstruction and data processing facility for image reconstruction and image transmission back to the display of the cell phone type-device.

### TECHNICAL FIELD

The present invention relates to cell phones and to imaging systems.

### BACKGROUND OF THE INVENTION

Medical imaging has become indispensable to modern medicine. However, it is expensive, and requires advanced infrastructure. As such, current medical imaging systems are expensive, and require trained operators to use, update and to repair. In addition, the costs of shipping medical imaging equipment from developed nations into lesser developed nations can also be prohibitive, and resources may not be available to operate the equipment when it arrives. Moreover, a large part of the costs of conventional medical imaging systems are due to the fact that they are self contained units that combine data acquisition hardware with software processing hardware in one device. This causes substantial duplication in expensive components between devices and increases cost. Therefore, medical imaging typically benefits mostly industrialized countries or urban communities.

As a result, three quarters of the world's populations lack access to standard medical imaging systems such as ultrasounds, X-rays and other imaging devices used for everything from detecting tumors to monitoring fetuses.

In contrast, cellular phone are widely available, even in remote areas, and are found throughout poor nations of the world. In fact, in many developing countries cell phones are available whereas standard land lines may not be.

What is now desired is a system that uses the ubiquity of cellular phone and the scarcity of medical imaging equipment around the world to provide medical imaging resources to patients in places and conditions where it was previously not available.

### SUMMARY OF THE INVENTION

One aspect of the present invention is to provide a system in which a conventional cellular phone is used as an integral, internally embedded and enabling component to transfer data among the components of a medical imaging system with spatially dispersed components. It is to be understood, however, that the present invention can also be used for producing other images (i.e. besides medical images). Other uses that do not entail any imaging are also encompassed by the present invention, as will be detailed below.

In exemplary aspects, the present invention uses a conventional cellular phone to serve as a data conduit between a medical imaging data acquisition device at a patient site and a distant image reconstruction and data processing facility (which may be located anywhere in the world). The cellular phone can be also used for local image display and for local processing at the patient site. As such, the standard cellular phone is used to transfer data between two independent components of a medical imaging system (data acquisition and image reconstruction). The entire complex comprised of the data acquisition component, the cellular phone component and the image reconstruction component are geographically separate at substantial distances from each other, even on other continents, but function as an integrated system through the use of cellular phone data transmission technology.

In preferred aspects, the invention comprises a simple data acquisition device (with limited controls and no image display capability) at a remote patient site that is connected via cell phone to an advanced central image reconstruction facility (that can be located anywhere in the world). The cell phone transmits raw, unprocessed or minimally processed data from the patient site to the central image reconstruction facility. The raw image data is then processed and reconstructed at the central image reconstruction facility and sent back to the cell phone (for display on the screen of the cell phone). This is significantly advantageous over conventional telemedicine where the image reconstruction and control is at the patient site and telecommunication is simply used to transmit processed images from the patient site. Alternatively, the data transfer back to the cell phone can be audible (instead of, or in addition to) being visual. For instance, a beep could be produced to when a medical condition such as internal bleeding is detected. Moreover, the audible signal may also be in the form of a telephone voicemail message.

In one exemplary application, the present system is used with electrical impedance tomography being the medical imaging modality. However, it is to be understood that the present invention is not so limited, and that other imaging modalities may also be used. For example, ultrasound, X-rays, magnetic resonance imaging (MRI), computerized tomography (CT) and positron emission tomography (PET) may be used for imaging. Moreover, in alternate uses, non-imaging data may also be handled by the present invention.

The present invention thus encompasses any system in which cellular phones are used as an integral, internally embedded and enabling component that transfers data among the components of the system, in a system with spatially widely dispersed components. The entire complex comprised of the data acquisition component, the cellular phone component and the data processing component are geographically separated but function as an integrated system through the use of the cellular phone.

An important advantage of the present design of the medical imaging system is that the most complex part of the system (i.e.: the processing software used to reconstruct the raw data into meaningful images) resides at one central facility. Thus, there is no need for people who are highly trained in image processing to be present in the field (i.e.: at the actual patient site, which may be in parts of the world with limited resources countries). Thus, an important advantage of the present invention is that it significantly reduces costs (since a single processor facility services multiple cell phone imager systems). Another advantage is that software updates can all be done at the central image processing facility (by trained personnel). The present invention therefore operates on any cell phone that can send and receive pictures or audio and video clips. This further keeps costs low and patient accessibility high. In addition, a centralized database can be maintained in the data processing facility. This database would preferably be compatible with all imaging modes and it could be used to track specific patients or to compare images from one patient with images from already diagnosed patients. In other optional embodiments, the cell phone transmits data to the central image processing facility, but does not receive information or data or images back from the facility. Rather, trained operators and medical professionals at the central data processing facility may simply perform diagnoses, or collect data (without displaying an image of the phone screen for the patient to view).

In further optional embodiments, the present invention need not be limited to imaging systems at all, but may be used in other contexts as well. For example, in some aspects, the cell phone is simply used as a data conduit between any two devices to replace hard wiring such that the cell phone is a “middle node” of a system (thus permitting component devices of the system to be positioned at various locations). This optional embodiment is in contrast to exiting communication systems in which cell phones operate as the end node of the system.

Thus, the present invention also provides a system of transferring data between parts of a complex device using cell phone communication protocols: comprising: a first system component of a complex device; a second system component of a complex device; and a cell phone-type device, wherein raw data is sent through the cell phone-type device from the first system component to the second system component of the complex device.

### BRIEF DESCRIPTION OF THE DRAWINGS

FIG. 1 is an illustration of the operation of the present invention (for a patient self-screening for breast cancer tumors).

FIG. 2 is a schematic representation of a frequency-division multiplexing electrical impedance tomography technique performed by a data acquisition device in accordance with the present invention.

FIG. 3 is an illustration of an exemplary architecture of a data acquisition device that can be used in accordance with the present invention.

FIG. 4A is an illustration of an exemplary minimally invasive surgical application in which a data acquisition device is used with a gel representing a tissue area treated with electroporation surrounded by normal tissue.

FIG. 4B is an illustration of a processed image corresponding to FIG. 4A as seen on the screen of a cell phone.

FIG. 5A is an illustration of an exemplary breast cancer detection application in which a data acquisition device is used with a gel representing a breast cancer tumor surrounded by normal tissue.

FIG. 5B is an illustration of a processed image corresponding to FIG. 5A as seen on the screen of a cell phone.

FIG. 6 is an illustration of the present invention as used in a non-imaging data transfer context, with a cell phone operating as a middle node of the system.

FIG. 7 is a second illustration of the present invention as used in a non-imaging data transfer context, with a cell phone operating as a middle node of the system.

### DETAILED DESCRIPTION OF THE DRAWINGS

### (a) Medical Imaging Systems

In accordance with the present invention, a conventional cellular phone is used as an integral and enabling component of a spattialy dispersed medical imaging system.

In preferred aspects, the cell phone and a data gathering device are used at a patient site, with the cell phone communicating with a multi-server processing center (possibly in a completely different part of the world). The multi-server processing center simultaneously serves many patient data gathering devices in the field. The multi-server processing center thus preferably acts as a central image reconstruction and data processing facility.

Specifically, the cell phone at the patient site transfers the raw data to an image reconstruction and data processing facility which then returns a reconstructed image through the cell phone. The cell phone is also used to display the image and for some local processing at the patient site. As will be explained, the fact that the image itself is produced in a centralized location and not on the measurement device has many advantages. For example, the data passing through the cell phone to the image reconstruction facility can be analyzed by experts and the software in the centralized facility can be continuously upgraded.

As will be shown, the cellular phone may be used in one of three ways: (a) as a communication channel for long distance data transfer between the data acquisition device and the image reconstruction and data processing facility, (b) as a local image display and Graphical User Interface (GUI) at the patient site in the field; and optionally (c) as a supporting limited local data processing unit at the patient site in the field, to provide partial support of the distributed system.

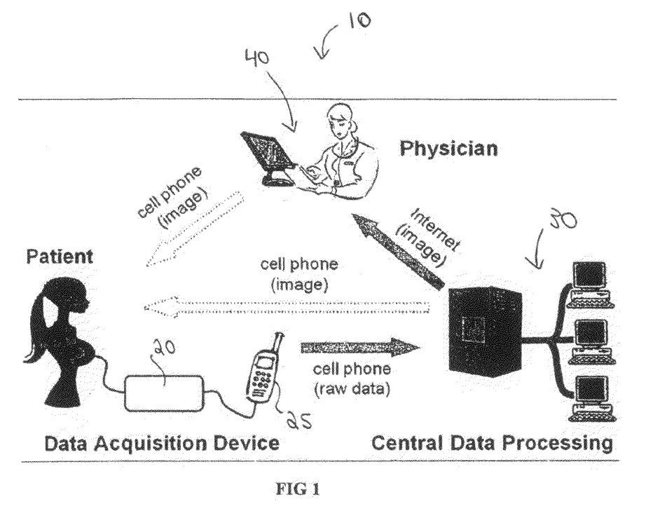

A schematic diagram of the system is given in FIG. 1 in which an imaging system 10 is provided. System 10 comprises an imaging data acquisition device 20; an image reconstruction and data processing facility 30; and a handheld cell phone typedevice 25. Cell phone 25 wirelessly transmits raw data from imaging data acquisition device 20 to remote image reconstruction and data processing facility 30. In addition, cell phone 25 also receives image data from remote image reconstruction and data processing facility 30 to display an image on a screen of the handheld cell phone 25. As described herein, “cell phone” 25 may include any cellular phone type-device, including but not limited to a cell phone, Personal Digital Assistant (PDA) or Blackberry™.

In preferred aspects of operation, a plurality of separate imaging data acquisition devices 20 and associated cell phones 25 are used together with a single central single image reconstruction and data processing facility 30. (For clarity in FIG. 1, only one data acquisition device 20 and cell phone 25 are illustrated). In preferred embodiments, image reconstruction and data processing facility 30 may comprise a large, centralized multi-server processing facility. As such, image reconstruction and data processing facility 30 may preferably be located in a resources rich part of the world, and be staffed with trained imaging professionals. Image reconstruction and data processing facility 30 preferably receives data from, and sends images to, a plurality of cell phones 25 that may be located at various patient sites in the developing world.

In an optional embodiment of the invention, a data viewing center 40 in communication with remote image reconstruction and data processing facility 30 is also included. This data viewing center 40 preferably comprises at least a computer screen for viewing the same image that is displayed on the screen of the handheld cell phone 25. The data viewing center 40 and the remote image reconstruction and data processing facility 30 may communicate over the Internet, and/or they may communicate wirelessly.

As can be seen in FIG. 1, images may be transmitted to the patient for display on the screen of cell phone 25 either by: (a) direct wireless transmission from image reconstruction and data processing facility 30 to cell phone 25, or (b) direct wireless transmission from data viewing center 40 to cell phone 25, or (c) by both methods (a) and (b) together. This is an advantage of the present invention in that cell phone 25 may receive image data from either location and from substantial distances, through cell phone services that are not dedicated to this application. Using commercial cell phones and cell phone services for data transfer substantially reduces the cost of the data transfer and substantially increases the ability to implement this invention without the need for a special infrastructure. Note: the images sent wirelessly to cell phone 25 are shown as two dotted arrows in FIG. 1.

Most preferably, the data sent from data acquisition site (i.e.: from data acquisition device 20 through the cell phone 25 to image reconstruction and data processing facility 30) is raw unprocessed data or minimally processed data. Data transmitted from imaging data acquisition device 20 through cell phone 25 to image reconstruction and data processing facility 30 may optionally be sent by e-mail, SMS, MMSTelnet. Moreover, the data transmitted from imaging data acquisition device 20 to remote image reconstruction and data processing facility 30 may be sent as analog data through a voice channel of the cell phone 25. Other communication options are possible as well.

The present invention thus also provides a method of imaging, comprising: acquiring raw data from data acquisition device 20; transferring the acquired raw data wirelessly with cell phone 25 using commercial cell phone services to data processing facility 30; constructing an image from the raw data at image reconstruction and data processing facility 30; transferring the constructed image from image reconstruction and data processing facility 30 to cell phone 25; through commercial cell phone services and then displaying the constructed image on a screen of cell phone 25.

Optionally, transferring the acquired raw data wirelessly with cell phone 25 to image processing and reconstruction facility 30 comprises: transferring acquired raw data from a plurality of cell phone-type devices 25 (at different patient locations around the world) to a single central image processing and reconstruction facility 30. Optionally, some or all of the constructed images may be transferred from image reconstruction and data processing facility 30 to a data viewing center 40. In further aspects, images and data may be transferred from data viewing center 40 to cell phone 25.

In various aspects of the present invention, cell phone 25 may be operated in one or more of the following ways. First, it can be used as a simple modem. Depending on the cell phone model, many phones on the market today have either a built-in option or a possible add-on to enable them to function as a modem. This option may require that cell phone 25 is operated together with either a personal computer or an integrated modem interface. Secondly, data can be uploaded to cell phone 25 through a wireless or a wired link and then sent using the cell phone's links such as Email, short messaging service (SMS), multimedia messaging service (MMS)Telnet. This depends on the types of commercial service that the cellular provider supports. However, at least SMS is a widely available option today, even in the simplest cellular networks. Third, a customized modem many be used. An advantage of this third approach is that it would be completely independent of the cell phone model. Thus, it would be possible to implement the customized modem with a suitable speaker that would match an ordinary cell phone microphone. In this case, the cell phone uses the voice channel to transmit an analog signal (much like a fax). This also offers advantages in terms of cell phone compatibility.

A further advantage of the present system is that almost every cellular provider, whether it is using GSM (global system for mobile communications), CDMA (code division multiple access) or other protocols supports a few PDA (personal digital assistant) like cell phone models that are relatively easy to work with and connect to. However, an intermediate option is to use cells phones that support some minimum features such as USB (universal serial bus) connection and color display. Using commercial cellular providers and cell phone data transfer technology has the advantage that it reduces the cost and the complexity of the system and it removes the need to build a dedicated data transfer system.

As stated above, the processed image can be displayed on the screen of the cell phone. An advantage of using the cell phone for the final image display and GUI is that creating the cell phone GUI application depends on the cell phone model and its support of Java or a similar technology. As such, the interfaces for displaying the final images on a plurality of cell phones at different patient locations need not be controlled from the central data processing facility. This is a further advantage of the present invention since the present system thus does not require a built-in display and/or keyboard and the user will not need a PC to use the device (although that is also an option as laptops are widely available). Using the cell phone's keypad, the user can also configure the system, run built-in test functions and operate the device. Optionally, the cell phone can be also used in a limited way for some of the data processing. This option may be useful in the case of a PDA like cell phone model since these PDA cell phones have relatively powerful processors.

The present invention also provides a method of imaging, comprising: acquiring raw data required for imaging with a mostly self supported device dedicated primarily to data acquisition; transferring the acquired data wirelessly with a cell phone through a commercial cell phone service provider; and producing the image with a distant mostly self supported device dedicated primarily to production of an image and data processing. The image can be transferred from the image production device to the cell phone through non-dedicated commercial cell phone services; and the image can be displayed on the cell phone screen.

The present invention also provides a method of acquiring raw data and sending the data through a cell phone to reconstruct the data remotely, comprising: acquiring an image with an imaging data acquisition device; using a handheld cell phone type-device to wirelessly transmit data representing the image from the imaging data acquisition device to a remote image reconstruction and data processing facility. In various aspects, the handheld cell phone type-device receives, or does not receive, data from the remote image reconstruction and data processing facility.

In preferred embodiments, imaging data acquisition device 20 is a medical imaging data acquisition device, and system 10 displays a medical image on the screen of cell phone 25 (for the patient or operator to view).

In preferred embodiments, the medical imaging methodology is electrical impedance tomography (EIT), and medical imaging data acquisition device 20 is an electrical impedance tomography system. It is to be understood, however, that the present invention is not so limited and that alternate imaging methodologies may be used. An advantage of using the present invention with EIT is that the “front end hardware” (i.e.: data acquisition device 20) is relatively inexpensive. In addition, EIT use measurements of currents and voltages from a set of electrodes placed outside the tissue or the body can be used to produce an image of the interior of the tissue or body, which can then be displayed as a map of the electrical impedance.

Moreover, EIT image reconstruction is computationally demanding, and requires sophisticated software. The image is reconstructed through a solution of the so-called “inverse problem” (i.e. determining impedance distribution inside the object from electrode current and voltage measurements around the object). Since the formulation of the problem is ill-posed in a mathematical sense, adequate reconstruction of the data into an image requires elaborate calculations that necessitate powerful signal processors and computer memory. The advantage of the present invention is that these functions are carried out in central image reconstruction and date processing facility 30 (as opposed to being carried out with equipment at the patient site).

Systems for separating the functions of data acquisition from those of processing and imaging have been set forth in U.S. Pat. No. 6,725,087, incorporated herein by reference in its entirety for all purposes. Specifically, the system set forth in U.S. Pat. No. 6,725,087 separates the functions of data acquisition from those of processing and imaging, and by connecting the data acquisition, processing and imaging components through a communication network, permit the data acquisition, processing and imaging functions to be carried out at disparate locations within the network. The present invention represents a novel and non-obvious advancement over that the system of U.S. Pat. No. 6,725,087 in that the present invention uses cell phone-type device for the transmission of data. In addition, the present invention uses a cell phone's own screen to display the image to the patient or user. The advantage of using broad use commercial cell-phone technologies are that the cost of data transfer is substantially reduced and the need for a hard-wired infrastructure is eliminated, thereby reducing cost and increasing the geographical range in which this technology can be applied.

When performing EIT, image processing and reconstruction facility 30 may advantageously be used to implement tasks that are not usually implemented in clinical systems due to their demanding requirements in terms of processing power and/or memory. For example: real time mesh generation for scenarios where the location of the electrodes may change, or hierarchical meshing in real time for regions where some inhomogeneity is detected, or suggestions on where to place the data gathering elements to obtain better information.

In optional exemplary methods of use, the present invention can be used to detect cancer tumors or monitor minimally invasive surgical procedures, such as electroporation (the permeabilization of the cell membrane with electrical pulses for genetic engineering, drug delivery, or tissue ablation).

Advantages of the invention include the fact that there is no need to manipulate the imaging software at the patient site. In addition, an excellent quality of imaging can be obtained at the data processing site. Non-dedicated commercial cellular phones are ubiquitous cheap and replaceable. Also, the cost of the data acquisition system (20 and 25) is low relative to the cost of the reconstruction system (facility 30) for a single imaging system. Furthermore the use of cellular phone make the concept feasible at sites that do not have readily available data transfer infrastructure and without the need to build an infrastructure.

Although the present system is ideally suited to medical imaging, potential other medical applications exist that could employ the use of cell phones in the mode described above and that involve the steps of acquisition of raw data, the processing of the raw data and the display of the processed data.

For example the present system can be used to detect the occurrence of internal bleeding through such technologies as those described in “Gonzalez, A. C., Rubinsky, B. “A theoretical study on magnetic induction frequency dependence of phase shift in oedema and haematoma”. Physiol. Meas. 27 (2006) 829-838.” and “César A González, Liana Horowitz, Boris Rubinsky, Detection of intraperitoneal bleeding by inductive phase shift spectroscopy, IEEE Trans. on Biomedical Engineering, Vol 54. No 5. May 5, 2007”. Particular to those systems is that two electromagnetic coils or magnetrons are placed in such a way that the tissue of interest is between the coils. The relation between the emitted and received electromagnetic signals is monitored at all times in a wide range of frequencies. Changes in the relation between the emitted and the received signals are used to detect changes in tissue properties indicative of such occurrences as edema, ischemia, internal bleeding. A possible application of this system is to detect internal bleeding in women after childbirth. Statistics show that one of four women who die at childbirth the cause of death is undetected internal bleeding. According to our present invention, the raw data from a device that measures the relation between the emitted and received electromagnetic signals in a wide range of frequencies from coils placed on a patient can be transmitted through a cellular phone to a central substantially remote data processing facility. The raw data can be analyzed either in relation with an available data base or through signal processing and the occurrence of internal bleeding can be noted to the patient site either as a visual message, or through a sound message, or through an SMS message. This concept could be particularly valuable to women in remote villages or clinics or in an ambulance where data processing and analysis may not be readily available. In a remote village that has cellular phone data transfer technology a women after childbirth could be connected to two electromagnetic coils. The raw data could be continuously transferred through the cell phone to a remote central facility, for instance in a nearby major village. Once internal bleeding is detected the information is send back to the cell phone that transmits the raw data and the women with internal bleeding could be immediately transferred to a large city hospital, thereby saving her life. Similarly in an ambulance a patient who has developed internal bleeding in the head could have their condition detected while on the way to the hospital by sending the raw data ahead of the ambulance through a cellular phone to the data processing facility at the hospital. This could make the delivery of proper treatment more rapid.

It should be emphasized that the systems described in this invention are different from conventional telemedicine. While in conventional telemedicine the data that is transferred is processed data in the system of this invention the data that is transferred is unprocessed or minimally processed data. This has the advantage that the components at the site of the patient can be substantially less complex requiring less maintenance and reducing cost. It should be further emphasized that the system of this invention deals with the use of commercial cell phone technology in which the providers support general cell phone services. The non-specificity of the data transfer technology substantially reduces the cost of using this concept. Furthermore the use of conventional commercial cell phones do not employ hard wiring for transfer of data between the different components of the distributed system. This has the advantage that the technology described here does not require a hard wired infrastructure and can therefore be used in locations that do not have access to the infrastructure such as in remote or limited resources villages and clinics, in ambulances or in the field. In various embodiments, the raw image data could correspond to optical data (pictures) and that the work performed at the data processing facility includes both quantitative and qualitative parameters, rather than simply creating an image. This approach can also be applied to other imaging modes. For example, the remote processing site could analyze mole pictures to assess whether they could correspond to melanomas. “Continuous mole monitoring” is now considered one of the best methods for early detection of melanomas. Presently, some dermatologists make use of digital pictures to track changes in size of morphology of specific moles. This is a tedious task that involves visits every few months.

In optional aspects of the present invention, a similar process can be used with the camera of the cell phone being used by patient to make pictures of specific moles as instructed by dermatologist or of new moles (some special lighting may be required). Next, the pictures would be sent to the data processing center, and then analyzed to detect significant changes (i.e.: comparing the pictures to previous patient pictures already stored in the central data center). As such, the present system could be used to determine whether any new or existing moles are becoming suspicious, and therefore whether a visit to a dermatologist is recommended or not.

### (b) Medical Imaging Experimental EIT Results

The present inventors have built, operated and experimentally verified the present invention using EIT components and systems described below. It is to be understood that the present invention may be carried out using other devices and processes, all keeping within the scope of the present invention.

An EIT scan is generally performed by placing a series of electrodes in a predetermined configuration in electrical contact with the tissue to be imaged. A low level electrical sinusoidal current is injected through one or more of the electrodes and a resulting voltage is measured at the remaining electrodes. This process may be repeated using different input electrodes, and electrical currents of different frequencies. By comparing the various input currents with their corresponding resulting voltages, a map of the electrical impedance characteristics of the interior regions of the tissue being studied can be imaged. It is also possible to map the impedance characteristics of the tissue by imposing a voltage and measuring a resulting current or by injecting and measuring combinations of voltages and currents. By correlating the impedance map obtained through an EIT scan with known impedance values for different types of tissues and structures, discrete regions in the resulting image can be identified as particular types of tissue (i.e., malignant tumors, muscle, fat, etc.)

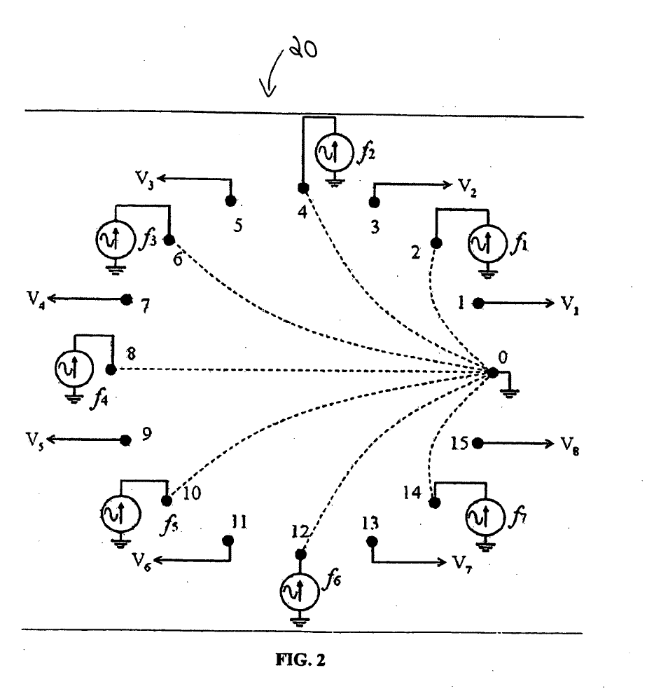

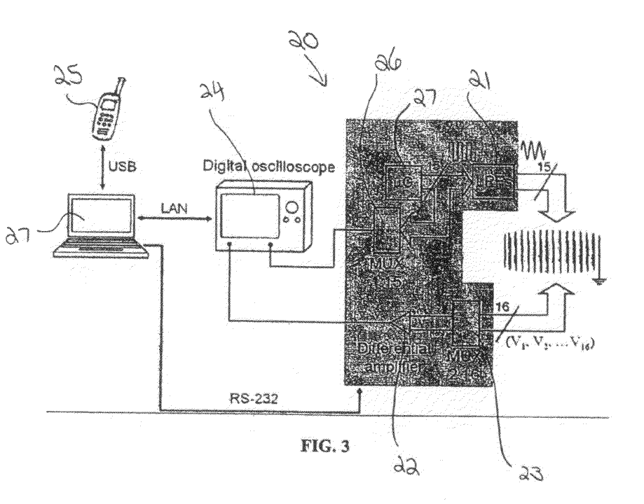

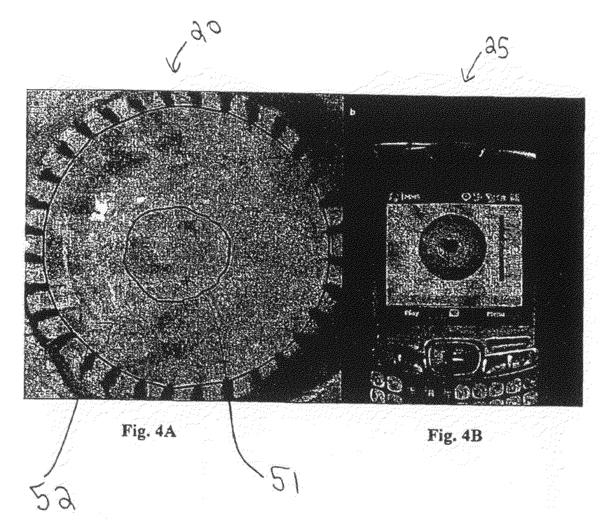

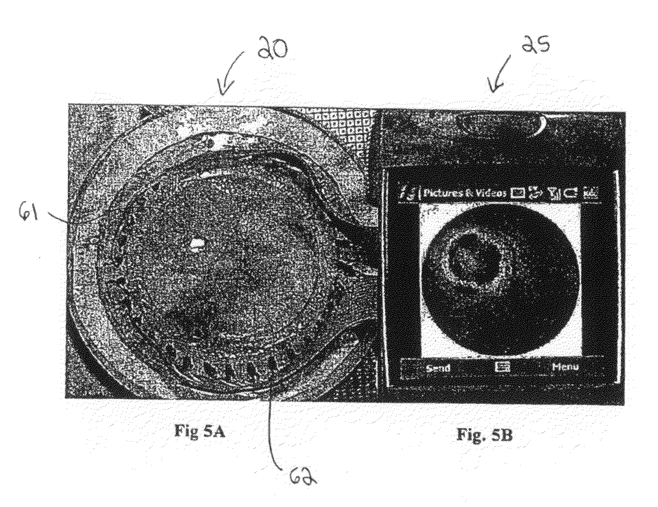

FIGS. 2 to 5B illustrate experimental system configurations and resulting images produced in accordance with experimental EIT testing of the present invention. Specifically, FIG. 2 is a schematic representation of a frequency-division multiplexing EIT technique carried out by the exemplary data acquisition device of FIG. 3. Details on the frequency multiplexing system can be found in: “Yair Granot, Antoni Ivorra, and Boris Rubinsky, “Frequency-Division Multiplexing for Electrical Impedance Tomography in Biomedical Applications,” International Journal of Biomedical Imaging, vol. 2007, Article ID 54798, 9 pages, 2007. doi:10.1155/2007/54798″. FIG. 4A shows a data acquisition device used with a gel representing a tissue area treated with electroporation surrounded by normal tissue, and FIG. 5A shows a data acquisition device used with a gel representing a breast cancer tumor surrounded by normal tissue. FIG. 4B shows the processed image corresponding to FIG. 4A, and FIG. 5B shows the processed image corresponding to FIG. 5A.

In one preferred aspect, as illustrated in FIGS. 2 and 3, data acquisition device 20 is an electrical impedance tomography system that comprises: a set of electrodes (1, 2, 3, 4, 5, 6, 7, 8, 9, 10, 11, 12, 13, 14 and 15 in FIG. 2) to inject currents or measure voltages; a current source 27 to send a predefined set of currents to the set of electrodes; at least one analog to digital converter to measure voltages from the set of electrodes; a system controller; and a communication port to communicate with cell phone 25. Advantageously, there is no need for a powerful central processing unit (CPU), hard disk or memory space or even a graphical display at the patient location. (Note: in FIG. 2, only sixteen electrodes out of an actual thirty two electrodes used in the experiment are shown for clarity).

As seen in FIGS. 4A and 5A, a set of electrodes (1, 2, 3, 4, 5, 6, 7, 8, 9, 10, 11, 12, 13, 14 and 15 in FIG. 2) were disposed around the tissue to be examined. A circular dish was used with gel representing the tissue samples. The needles had a length of 20 mm and the circular container had a diameter of 65 mm. Some of the set of electrodes were used for current injection, some of the set of electrodes were used for voltage measurement, and some of the set of the electrodes were used for both the current injection and voltage measurements. Specifically, fifteen electrodes were current sources, one was a current sink and sixteen were used for voltage measurements. Each current electrode injected an AC type current (amplitude 80 uA) at a different frequency. The frequencies were all in the 5 kHz to 20 kHz band (for which the conductance of physiological solutions or gels is constant). The injected AC currents were obtained from square signals generated by a set of low cost micro-controllers 27 FIG. 3 (PIC16F76 by Microchip Technology, Inc.) that were filtered by second-order lowpass filters 21 FIG. 3 (LPFs) with a quality factor (Q) of 4 and centered at the frequency of interest.

A differential amplifier 22 (AD830 by Analog Devices, Inc.) was connected sequentially to different voltage electrode pairs by means of an analogue multiplexer 23 (MUX 2:16). The signal was then acquired by a digital oscilloscope 24 (LeCroy, WaveRunner 44Xi). Oscilloscope 24 also recorded the voltages from the current injectors through another analogue multiplexer 26 (MUX 1:15). All the recorded signals are acquired by a laptop computer 27 (IBM ThinkPad T43) with a LAN connection to oscilloscope 24.

Cell phone 25 was a Palm Treo 700W. All of the AC signals (each at a different frequency) were injected simultaneously. Signals from voltage electrodes (V1 to V8) were connected to analogue multiplexer 23 (In a clinical device, computer 27 and oscilloscope 24 will be most likely replaced by dedicated components.)

The current source was based on a Tektronix AFG 3102 signal generator connected to 27 (not shown).

The gray shaded area contains the elements that were implemented on a single printed circuit board: a microcontroller (not shown) reads incoming commands from the computer (through the RS-232 connection) and, according to these commands, manages the digital control lines of the analog multiplexers 26 and 23 (i.e. MUX 1:15 and MUX 2:16).

The whole process was performed through custom developed Lab VIEWroutines (National Instruments Corporation, Austin, Tex.). Using FDM (frequency division multiplexing) EIT, the voltage measurements were separated according to frequency. The different current patterns that were injected simultaneously are correlated with the voltage measurements. The signal processing routines that extract the voltage data were based on the Fourier transform and were implemented in Matlab (www.mathworks.com). In the last step of processing at the cell phone site, the computer 27 transmitted the resulting raw data through cell phone 25 by means of a USB connection. The format of the raw data is detailed below.

A total of fifteen electrodes injected a current of to a single sink as explained above, but it is to be understood that various other patterns may be used as well. For each current there were fifteen independent voltage pair measurements (electrodes 1-3, 3-5, . . . , 29-31) which were obtained by the FFT (Fast Fourier Transform) as detailed above. Since there are fifteen current injections and for each one fifteen voltage measurements, there were a total of two hundred and twenty five measurements taken.

The measurements were arranged in a matrix to be transmitted to the processing center. Every measurement was written in a row of the matrix. The columns described the injected signal's frequency, the injecting electrode number, the positive voltage electrode number, the negative voltage electrode number, the measured voltage amplitude and the phase. For predefined patterns, it was sufficient to report only the last two columns. In our experiments, this matrix is 225 rows by 6 columns and its size is 4 kB. This matrix was uploaded to cell phone 25, which dials the processing center 30 and uploaded the matrix though a standard HyperTerminal data link.

In data processing computer 27, a Matlab program was used to reconstruct the image which was sent back to cell phone 25 in the form of an ordinary multimedia message using the cell phone service provider's standard web-based interface. The Matlab program was based on EIDORS (see paper of Granot et al above). However any other EIT reconstruction algorithms could be used. Cell phone 25 was connected to computer 27 via a USB data cable interface.

Note: FIG. 3 illustrates an experimental embodiment to verify the operation of the present invention. As such, computer 27 is merely simulating the operation of facility 30 (in FIG. 1). As such, the embodiment of the invention shown in FIG. 3 was merely built to show the operation of successful data acquisition (by data acquisition device 20) followed by successful transmission of the processed image to the screen of cell phone 25. It is to be understood that computer 27 (located between data acquisition device 20 and cell phone 25 in FIG. 3) is specifically not required in accordance with the present invention. Rather, as shown in FIG. 1, the computer processing resides at facility 30 (with data acquisition device 25 being positioned between cell phone 25 and facility 30).

In order to reconstruct the image from the voltage measurements that were sent from cell phone 25, a Laplace equation over the entire tissue was solved. Specifically, by injecting a set of currents known as a current pattern and from performing voltage measurements, the boundary conditions of the tissue were determined. Thus, the internal conductivity of the tissue was computed. A Finite Element Method (FEM) was used to compute the voltages resulting from applying the current pattern and these were compared to the measured voltages. When they matched, the conductivity was determined.

FIG. 4A and FIG. 5A illustrate testing in two situations of interest to medical imaging: minimally invasive surgery with irreversible electroporation (FIG. 4A) and cancer tumor detection (FIG. 5A). In both cases, gels were used in a two dimensional configuration to simulate the conductivity of different tissues.

In FIG. 4A, a gel is shown with the electrical properties of irreversible electroporated liver tissue (0.93 mS/cm) nested within a gel with electrical properties of normal liver tissue (0.65 mS/cm). Simulated electroporated region 51 and normal liver region 52 are shown. The border between regions 51 and 52 were manually marked between the two gels to help identify the location of the inhomogeneity and to compare the reconstructed image to the actual location of the gel. The conductivity of the gel in region 52 is 0.65 mS/cm which is similar to that of a normal liver tissue. A cylinder was cut in the central part of the gel and replaced it with another gel 51 with a higher conductivity of 0.93 mS/cm which is similar to the conductivity of a liver after irreversible electroporation. FIG. 4B shows the resulting on-screen medical image as seen on cell phone 25.

In FIG. 5A, a simulated breast cancer tumor 61 is shown (having a conductivity of 6 mS/cm @ 100 kHz) (upper left side circle) surrounded by normal tissue 62 (0.3 mS/cm @ 100 kHz). FIG. 5B shows the resulting on-screen medical image as seen on cell phone 25.

In summary, these experiments demonstrated the successful use of a cellular phone as an integrated and enabling part of a medical imaging system in which the data acquisition component is connected to the imaging processing site through a commercial cell phone. This concept has the potential for reducing the cost of medical imaging devices and because of the wide availability of cellular phones and commercial cell phone services produce medical images in a way that could bring state-of-the-art medical imaging to people and places that are not able to afford more standard equipment. Potential medical applications include, but are not limited to detection of tumors, disease and internal bleeding.

The present invention is easily scalable and could be used in a very similar manner for 3D EIT. Specifically, with the increase in number of electrodes, or the number of current patterns that are used, the size of the measurement matrix increases slightly and in a linear fashion while the requirements from the processing center in terms of memory and processing power increase significantly, usually in a quadratic fashion. This makes the system scalable with only small changes to data acquisition device 25, which is typically the hardest place to implement changes in terms of logistics and cost.

### (c) Data Transfer Applications

As described fully above, the present invention is ideally suited for transferring (medical or non-medical) images that use raw data (sent by cell phone 25) and then display processed images on cell phone 25's screen.

It is to be understood, however, that the full potential of the present invention involves data transfer between component parts of any complex device or system—where a cell phone and commercial cell phone services are used for data transfer between the component parts of the device or system. Thus, an advantage of the present invention is that it can use a cell phone as a “middle node” in a system, complex device or machine. An advantage of the present use of a cell phone as a “middle node” in a system, complex device or machine is that it can be used to replace hard wiring. As such, the various component parts can be separated and placed in substantially distant physical locations, that may be economically or geographically more advantageous. Using commercial cell phone services for data transfer between the components of a system can substantially reduce the cost of standalone systems because it can remove redundancy in the cost of components. The availability of commercial cell phone services substantially reduces the cost of data transfer for such systems.

The present invention provides for a system in which cellular phones are used as an integral, internally embedded and enabling component that transfers data among the components of the system, in a system with substantially distant spatially dispersed components. The entire complex is comprised of the data acquisition component, the cellular phone using a commercial non-dedicated data transfer service component and the data processing component. They are geographically separated but function as an integrated system through the use of cellular phone.

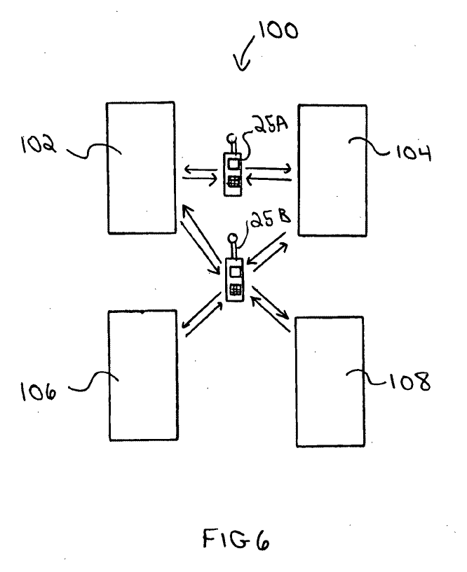

In such alternate aspects, as seen in FIG. 6, the present invention provides a system of transferring data between parts of a complex device using cell phone communication protocols: comprising: a first system component 102 of a complex device 100; a second system component 104 of complex device 100; and a cell phone-type device (25A), wherein raw data is sent through cell phone-type devices 25A from first system component 102 to second system component 104. An example of a non-medical application is interior mapping of ground in the field, such as for identification of oil fields. Systems 106, 108 may be a set of pressure transducers located in the field around a geographical area of interest. A local detonation 100 can produce pressure waves that are recorded in 106 and 108. The raw data is send to 102 and the information processed to produce a map of the soil in the area of interest. Site 104 may be a complex data base of information that could be at a different location from the data processor in 102 and used by 102 to compile the image. As shown by the bi-directional arrows in FIG. 6, data is transferred by cell phone 25A back and forth between components 102 and 104 (such that components 102 and 104 need not be hard wired together.

As is also seen in FIG. 6, a second (optional) cell phone 25B is also provided. As illustrated, cell phone 25B may be used to transmit data between any of first and second components 102 and 104, and also between third component 106 and fourth component 108. Thus, the present invention broadly encompasses using one or more cell phones for data transmission between or among various components of a complex device.

The present invention thus encompasses the concept of a cell phone as a “middle node” in any complex system. This is an important advance over all prior art systems where a cell phone is simply the “end node” of a complex telecommunication network.

Similar to the above described systems, cell phones 25A and 25B may be any cell phone, PDA or Blackberry™, and data transmitted through the cell phone may be sent by the cell phone by e-mail, SMS, MMSTelnet. Moreover, such data may be transmitted as analog data through a voice channel of the cell phone. Preferably, the data sent through cell phones 25A and 25B is raw unprocessed data or minimally processed data.

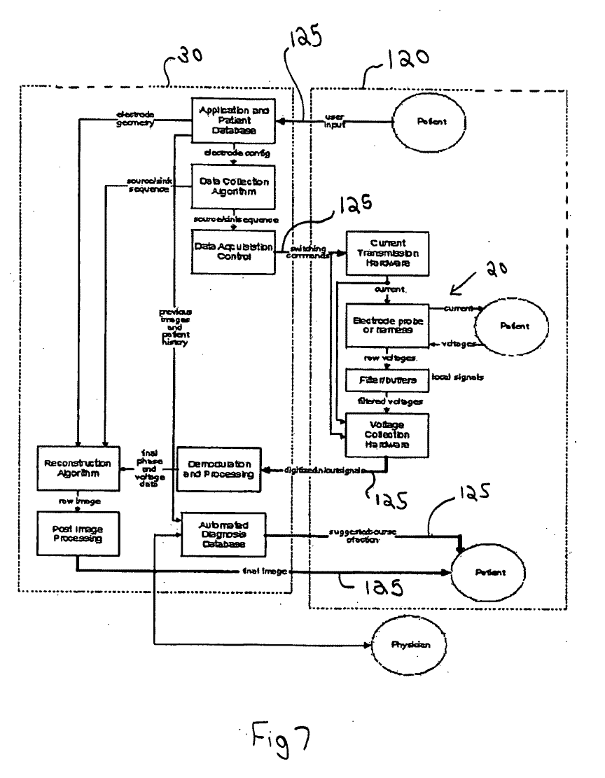

Lastly, as seen in FIG. 7, a distributed network can be seen in which cell phones are used to transmit data. The system of FIG. 7 is similar in operation to the system set forth in Distributed Network Imaging and Electrical Impedance Tomography of Minimally Invasive Surgery, Technology in Cancer Research & Treatment, ISSN 1533-0346, Vol. 3, No. 2, 2004. In this system, facility 30 comprises a remote central facility, and patient site 120 comprising the patient and data acquisition device 20. However, in accordance with the present invention, the data transmitted between patient site 120 and central facility 30 is transmitted by cell phone (using methods as described above). Specifically, data transmitted at lines/pathways 125 may be transmitted by one or more cell phones 25 (not shown).

What is claimed is:

1. An imaging system, comprising:
an imaging data acquisition device;
an image reconstruction and data processing facility; and
a handheld cell phone type-device, wherein the cell phone type-device wirelessly transmits data from the imaging data acquisition device to the image reconstruction and data processing facility, and wherein the handheld cell phone type-device receives image data from the image reconstruction and data processing facility to display an image on a screen of the handheld cell phone type-device.

2. The imaging system of claim 1, wherein the cell phone type-device is a cell phone, PDA or Blackberry™.

3. The imaging system of claim 1, wherein the imaging data acquisition device and the handheld cell phone type-device comprise a plurality of imaging data acquisition devices and handheld cell phone type-devices communicating with a central single image reconstruction and data processing facility.

4. The imaging system of claim 1, further comprising:
a data viewing center in communication with the image reconstruction and data processing facility.

5. The imaging system of claim 4, wherein the data viewing center comprises a computer screen for viewing the same image that is displayed on the screen of the handheld cell phone type-device.

6. The imaging system of claim 4, wherein the data viewing center and the image reconstruction and data processing facility communicate over the Internet.

7. The imaging system of claim 4, wherein the data viewing center and the image reconstruction and data processing facility communicate wirelessly.

8. The imaging system of claim 1, wherein the imaging data acquisition device is a medical imaging data acquisition device, and the system displays a medical image on the screen of the handheld cell phone type-device.

9. The imaging system of claim 8, wherein the medical imaging methodology is electrical impedance tomography.

10. The imaging system of claim 8, wherein the medical imaging data acquisition device is an electrical impedance tomography system.

11. The imaging system of claim 10, wherein the electrical impedance tomography system comprises:
a set of electrodes to inject currents or measure voltages;
a current source to send a predefined set of currents to the set of electrodes;
at least one analog to digital converter to measure voltages from the set of electrodes;
a system controller; and
a communication port to communicate with the cell phone type-device.

12. The imaging system of claim 11, wherein the set of electrodes are configured to be disposed around tissue to be examined.

13. The imaging system of claim 11, wherein some of the set of electrodes are used for current injection, and some of the set of electrodes of are used for voltage measurement and some of the set of the electrodes are used for both the current injection and voltage measurements.

14. The imaging system of claim 1, wherein the image reconstruction and data processing facility comprises a multi-server processing facility.

15. The imaging system of claim 1, wherein the image reconstruction and data processing facility receives data from, and sends images to, a plurality of the cell phone type-devices in different physical locations.

16. The imaging system of claim 1, wherein the data transmitted from the imaging data acquisition device to the image reconstruction and data processing facility is sent by the cell phone by e-mail, SMS, MMS Telnet or other supported communication protocol.

17. The imaging system of claim 1, wherein the data transmitted from the imaging data acquisition device to the image reconstruction and data processing facility is sent as analog data through a voice channel of the cell phone-type device.

18. The imaging system of claim 1, wherein the data sent from the data acquisition site is raw unprocessed data or minimally processed data.

19. A method of imaging, comprising:
acquiring raw data from an imaging data acquisition device;
transferring the acquired raw data wirelessly with a cell phone-type device to an image reconstruction and data processing facility;
constructing an image from the raw data at the image reconstruction and data processing facility;
transferring the constructed image from the image reconstruction and data processing facility to the cell phone-type device; and
displaying the constructed image on a screen of the cell phone-type device.

20. The method of claim 19, wherein transferring the acquired raw data wirelessly with a cell phone-type device to an image reconstruction and data processing facility comprises:
transferring acquired raw data from a plurality of cell phone-type devices at different locations to a single central image reconstruction and data processing facility.

21. The method of claim 19, further comprising:
transferring the constructed image from the image reconstruction and data processing facility to a data viewing center.

22. The method of claim 21, further comprising:
transferring data from the data viewing center to the cell phone-type device.

23. The method of claim 19, wherein the imaging data acquisition device is a medical imaging data acquisition device, and the system displays a medical image on the screen of the handheld cell phone type-device.

24. The method of claim 23, wherein the medical imaging methodology is electrical impedance tomography.

25. The method of claim 19, wherein the data transmitted from the imaging data acquisition device to the image reconstruction and data processing facility is sent by the cell phone-type device by e-mail, SMS, or MMS Telnet.

26. The method of claim 19, wherein the data transmitted from the imaging data acquisition device to the image reconstruction and data processing facility is sent as analog data through a voice channel of the cell phone-type device.

27. A system of transferring data between parts of a complex device using cell phone communication protocols: comprising:
a first system component of a complex device;
a second system component of a complex device; and
a cell phone-type device, wherein raw data is sent through the cell phone-type device from the first system component to the second system component of the complex device.

28. The system of claim 27, wherein the cell phone type-device is a cell phone, PDA or Blackberry™.

29. The system of claim 27, wherein the data transmitted through the cell phone-type device is sent by the cell phone by e-mail, SMS, MMS or Telnet.

30. The system of claim 27, wherein the data transmitted through the cell phone-type device is sent as analog data through a voice channel of the cell phone-type device.

31. The system of claim 27, wherein the data sent from the data acquisition site is raw unprocessed data or minimally processed data.

32. A system, comprising:
a data acquisition device;
a data processing facility; and
a handheld cell phone type-device, wherein the cell phone type-device wirelessly transmits data from the data acquisition device to the data processing facility, and wherein the handheld cell phone type-device receives data from the data processing facility to display an image on a screen of the handheld cell phone type-device.

33. The system of claim 32, wherein the cell phone type-device is a cell phone, PDA or Blackberry™.

34. The system of claim 32, wherein the data acquisition device and the handheld cell phone type-device comprise a plurality of data acquisition devices and handheld cell phone type-devices communicating with a central single data processing facility.

35. The system of claim 32, wherein the data transmitted from the data acquisition device to the data processing facility is sent by the cell phone by e-mail, SMS, MMS Telnet or other supported communication protocol.

36. The system of claim 32, wherein the data transmitted from the data acquisition device to the data processing facility is sent as analog data through a voice channel of the cell phone-type device.

37. The system of claim 32, wherein the data sent from the data acquisition site is raw unprocessed data or minimally processed data.

38. The system of claim 32, wherein the system is a medical system, and wherein the data acquisition device is a medical data acquisition device.

39. A method of data acquisition and presentation, comprising:
acquiring raw data from a data acquisition device;
transferring the acquired raw data wirelessly with a cell phone-type device to a data processing facility;
constructing a result from the raw data at the data processing facility;
transferring the result from the data processing facility to the cell phone-type device; and
displaying the result on a screen of the cell phone-type device.

40. The method of claim 39, wherein transferring the acquired raw data wirelessly with a cell phone-type device to a data reconstruction facility comprises:
transferring acquired raw data from a plurality of cell phone-type devices at different locations to a single central data processing facility.

41. The method of claim 39, wherein the data acquisition device is a medical imaging data acquisition device, and the system displays a medical image on the screen of the handheld cell phone type-device.

42. The method of claim 39, wherein the data transmitted from the data acquisition device to the data processing facility is sent by the cell phone-type device by e-mail, SMS, or MMS Telnet.

43. The method of claim 39, wherein the data transmitted from the data acquisition device to the data processing facility is sent as analog data through a voice channel of the cell phone-type device.

44. An imaging system, comprising:
a data acquisition device;
an image reconstruction and data processing facility; and
a handheld cell phone type-device, wherein the cell phone type-device wirelessly transmits data from the data acquisition device to the image reconstruction and data processing facility.

45. The system of claim 44, wherein the imaging system is a medical imaging system and wherein the data acquisition device is a medical data acquisition device.

46. A method of imaging, comprising:
acquiring raw data from an imaging data acquisition device;
transferring the acquired raw data wirelessly with a cell phone-type device to an image reconstruction and data processing facility; and
constructing an image from the raw data at the image reconstruction and data processing facility.

47. The method of claim 46, wherein transferring the acquired raw data wirelessly with a cell phone-type device to an image reconstruction and data processing facility comprises:
transferring acquired raw data from a plurality of cell phone-type devices at different locations to a single central image reconstruction and data processing facility.

48. The method of claim 24, wherein image processing and reconstruction facility 30 performs at least one of real time mesh generation for scenarios where the location of electrodes may change, hierarchical meshing in real time for regions where some inhomogeneity is detected, or suggestions on where to place data gathering elements to obtain better information.
